(19) United States
(12) Patent Application Publication
(10) Pub. No.: US 2026/0029667 A1
(43) Pub. Date: Jan. 29, 2026

(54) SYSTEMS AND METHODS FOR EYEWEAR RECOMMENDATION

(71) Applicant: Bespoke, Inc. d/b/a/ Topology Eyewear, San Francisco, CA (US)

(72) Inventors: Eric J. VARADY, San Francisco, CA (US); Rob VARADY, San Francisco, CA (US); Stefano GIOMO, San Francisco, CA (US); Tamas BAJNOCZI, San Francisco, CA (US); Ion BIZIIAC, San Francisco, CA (US); Ibaad RAHMAN, San Francisco, CA (US)

(21) Appl. No.: 19/078,815

(22) Filed: Mar. 13, 2025

Related U.S. Application Data
(60) Provisional application No. 63/564,790, filed on Mar. 13, 2024.

(51) Int. Cl. G02C 13/00

(52) U.S. Cl. CPC G02C 13/005

(57) ABSTRACT

System and methods for recommending eyewear to a user are disclosed. The method may include receiving one or more images of a face of the user, extracting spatial information from one or more images using a deep learning model to estimate depth and contours of one or more facial features, reconstructing a three-dimensional facial model based on the extracted spatial information, wherein the reconstruction includes aligning a face mesh with a reference object of known size or an alternative scaling mechanism, tracking eye movement and analyzing gaze fixation points to determine natural viewing behavior, and/or generating an eyewear recommendation based optionally on the three-dimensional facial model and/or the analyzed viewing behaviors, wherein the recommended eyewear is selected to optimize fit and/or visual alignment and/or user explicit or implicit preferences.

### CROSS-REFERENCE TO RELATED APPLICATION

This application is a non-provisional of, and claims the benefit of priority to U.S. Provisional Application No. 63/564,790, filed on Mar. 13, 2024, the disclosure of which is incorporated herein in its entirety.

### BACKGROUND

In the realm of eyewear, finding the perfect frame and lens combination that not only suits your style but also complements your facial features can be a daunting task. Conventionally, frame and lens recommendations relied heavily on subjective assessment and manual measurements, often resulting in suboptimal outcomes. This approach failed to account for the intricate nuances of facial structures, eye dynamics, and individual preferences. Conventional systems are technically challenged in leveraging advanced data analytics and machine learning algorithms to provide personalized solutions. The present disclosure is directed to overcoming the shortfalls of such conventional systems.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIGS. 1-2 illustrate initialization questions used to gather comprehensive data for frame recommendations, encompassing factors such as style preferences and facial measurements, according to aspects of the disclosure. These are asking explicit preferences, as opposed to implicit preferences the user does not convey (or does not know how to convey, but they know it when they see it . . . often on their face in a mirror).

FIGS. 3A-3E illustrate a user interface allowing users to set gender and weight, among other things, as metadata to facilitate personalized recommendations in eyewear selection, according to aspects of the disclosure. A user could be an end-user/customer of eyewear, or a system designer.

FIG. 4 illustrates a user interface that presents initial sets of random frames, or a carefully selected set of opposing fames based on various data the system knows, offering users a diverse array of options to explore for their eyewear selections, according to aspects of the disclosure.

FIG. 5 illustrates a user interface that presents a final personalized ranking of frames after analyzing numerous characteristics of frames and/or how said frames fit a face, and/or the votes of a user after seeing one or more head-to-head images, according to aspects of the disclosure.

FIG. 6 illustrates a user interface that allows the users to click on any frame in the list, enabling them to preview the frame in a virtual try-on (VTO) mode and visualize how the score was calculated, according to aspects of the disclosure.

FIG. 7 illustrates a consumer-facing VTO interface to enable users to virtually try on two different styles of frames, in real-time and head-to-head, enhancing the shopping experience by providing a lifelike preview of how each frame looks on their face, and allowing them to select which one they like best, according to aspects of the disclosure.

FIG. 8 illustrates a consumer-facing VTO that allows users to seamlessly compare and select from distinct styles of frame, according to aspects of the disclosure.

FIG. 9 illustrates a consumer-facing VTO that compares and scores distinct styles of frame to aid in their selection process, according to aspects of the disclosure.

FIG. 10 illustrates a consumer-facing VTO debug console that offers real-time visualization and adjustment capabilities to seamlessly troubleshoot and fine-tune virtual eyewear selection for an optimal fit, according to aspects of the disclosure.

FIGS. 11A-11E illustrate detection and automatic correction of RGB and depth sensor misalignment, according to aspects of the disclosure.

### DETAILED DESCRIPTION OF EMBODIMENTS

As described above, conventional systems for recommending eyewear are technically challenged in leveraging advanced data analytics and machine learning algorithms to provide personalized solutions.

Achieving optimal recommendations requires a multifaceted approach, such as optionally leveraging depth from RGB deep-learning approaches, determining eye movements, and accurate alignment of face meshes. For example, by utilizing RGB deep learning approaches, the system may extract rich spatial information from conventional RGB images, enabling precise depth estimation of facial features and contours. Other approaches can accurately reconstruct a face without a depth sensor as long as a reference object of known size (or other means of accurate scaling) is leveraged. An additional example, by tracking gaze patterns and analyzing fixation points, eyewear recommendations can be fine-tuned to accommodate natural viewing behaviors. For example, aligning face meshes with precision is paramount in achieving a seamless fit. By digitally mapping facial contours and proportions, frame recommendations can be customized to complement unique features and preferences.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the embodiments are not to be considered as limited by the foregoing description.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

### Frame/Lens Recommendations Via Visual Experience

Eyewear frames have various metadata/attributes associated to them, such as style, shape, material(s), surface finish, color(s), nosepad geometry, brand, lens tint, lens treatment, rim thickness, temple height, etc. Eyewear frames also have measurements associated with them, such as A (horizontal lens width), B (vertical lens height), DBL (bridge width), temple length, full-rim/half-rim/rimless, etc. Eyewear frames can also have other dimensions provided by the manufacturer, and/or can be extracted from a 3D understanding of the frame. A subset of such measurements is shoulder width (distance from outermost edge of the lens to the outermost edge of the frame), height of the shoulder from the top edge of the frame, pantoscopic angle, eyewear rim thickness (in Y—in plane of the lens, top and bottom, and in Z (backwards from lens)), eyewear front frame thickness, temple height, temple thickness, volume (and thus weight if approximate density known), angle(s) of nosepads, bridge shape, lens shape, full-rim/half-rim/rimless, curved or straight-back temple ends, etc.

It is often the case that if you ask a customer what eyewear shape they like, they might have an approximate idea in their head, but often they'll know it when they see it. The same goes for many if not most of the metadata/attributes listed above. They do have explicit preferences—the preferences they know and can verbalize without seeing it on themselves, and then they have implicit preferences—those they may not know, or don't have the language to describe, but they know if they like it or not sometimes when they see it on a shelf, but definitely once worn on the face. Furthermore, the majority of customers do not know their head size, pupillary distance, or what “eyewear sizes” (aka A, B, DBL, temple length) are best suited to their faces. This fact explains why customers describe eyewear shopping as “trial and error”—they try on their face (physically or via a virtual try-on) a very large number of frames until they see ones they like that also “fit” their face. Customers cannot look at a frame sitting on a shelf, or photos of a frame in a whitebox, and accurately determine if it will look good on them, let alone fit them—they only know it when they see it.

Furthermore, customers are not adept at understanding the complexities and interdependencies of what frames are well suited to his/her unique vision prescription. For example, certain frames can hide thick edges of a lens better than others. But the edge thickness of a lens is dependent not only on the frame's A, B, and DBL, but critically where the eye is located within the lens relative to the geometric center of the lens—aka the binocular (or better monocular) pupillary distance, which determines the horizontal placement of the eye within the frame, and the optical center (OC) height (also known as seg height) which determines the vertical placement of the eye within the lens.
i. The latter OC height is also highly dependent on how a given frame's unique nose geometry will sit on a given user's unique nose physiognomy (and further whether the frame rests on the customer's cheeks).

Furthermore, how far up or down the nose the customer prefers to wear a given frame (assuming a frame can be adjusted to fit said desired position) will also affect OC height.
ii. Frames with adjustable nosepads can have extra degrees of freedom, as the nosepads can be adjusted to fit a wide variety of nose shapes and enable the positioning of the frame closer, farther, higher, and/or lower with respect to the customer's eye.
iii. The pantoscopic angle of the frame (with respect to the natural head posture of the user) can also have a smaller secondary effect on the edge thickness of a lens, and can also affect the aesthetics of the frame on the face.
iv. The more nasally (horizontally) or vertically decentered the optical center of a lens is, the thicker the edge thickness will become for a nearsighted minus sphere Rx, or the thicker the center thickness will be for a farsighted plus sphere Rx, regardless of lens index material chosen.

The stronger the lens' prescription Rx's sphere (SPH) or cylinder (CYL), the more one will want to reduce decentration horizontally and/or vertically.

The extent and location on the frame of maximum lens thickening based on CYL is determined by the axis of the astigmatism, and this too can be considered.

If the system has access to the trace file of a given frame, and the location of the optical center of the lens (based on pupil location within the lens), this information can be leveraged to have the most-accurate calculation of the location on the frame where maximum lens thickness would occur. If no trace file exists, then an approximation can be determined based on A, B, and DBL based on the geometric center of the lens (least-accurate), or better based additionally on the precise location of the optical center (based on pupil location within the lens). The location of the maximum edge thickness can be based on the approximate location of the furthest point on the frame based on the information available, optionally with an assumption of some degree of radius of the box of the lens (boxing procedures are known to those familiar in the art) calculated from the available frame information, since no frame is perfectly rectangular with perfectly-sharp edges. Optionally, the assumption of the radius of the box (or different radiuses of the box) can be based on the known categorization of frame shape. For example, the assumption of box radius of a round or pantos frame can be higher than that of a rectangular shape.
v. The thicker the lens, the heavier the lens, and certain customers are more motivated than others to achieve the lightest possible frame/lens pairing. Furthermore, the thicker the lens, the more distortion at the periphery and the less desirable the aesthetics.
vi. If the customer is a progressive lens wearer, then a minimum B size of the frame (or minimum OC or seg height) may be chosen to allow for enough vertical room for the lens' progressive corridor and magnification (ADD) area. Furthermore, certain frame designs, such as aviators, often cut away the lens precisely where the ADD area is often placed, and thus one needs a fit that achieves even higher minimum B or OC height—a different frame, or a different fitted placement on the face that lowers the lens with respect to the eye. But the latter will also consequently result in a thicker edge thickness at the periphery. The design of the progressive lens may optionally affect the minimum threshold of OC/seg height allowed.

Given the fact that customers “know it when they see it” with regards to a great frame for their face that meets all sizing and aesthetic criteria, but also given the fact that customers do not like answering, or are incapable of accurately answering, a series of questions, in the abstract, regarding what shapes, colors materials, brands, etc. they would like to see or have recommended, there is a need to photorealistically visualize via a virtual try-on (VTO) frames on customers' faces, and then via a series of inputs/votes/selections, a system must elicit, uncover, decipher, derive, etc. one or more of these implicit preferences, or intuit, infer, deduce, etc. one or more of these implicit preferences. Such a VTO must ideally display frames in metric scale (aka in the correct proportion with respect to the customers' face), and ideally position said frames on face precisely how they will fit in real-life.

In the evolving landscape of eyewear selection, traditional methods of choosing frames and lenses based on static images or manual measurements often fall short in delivering an optimal fit. To bridge this gap, system 101 may leverage deep learning, computer vision, and behavioral analysis to provide highly personalized recommendations. By optionally integrating depth estimation from RGB images, facial mesh alignment, and/or gaze tracking, the system 101 may ensure that users receive eyewear that not only complements their facial features but also aligns with their natural visual behavior. These inventions can also be leveraged independent of recommendations to enhance other products or features or system behaviors.

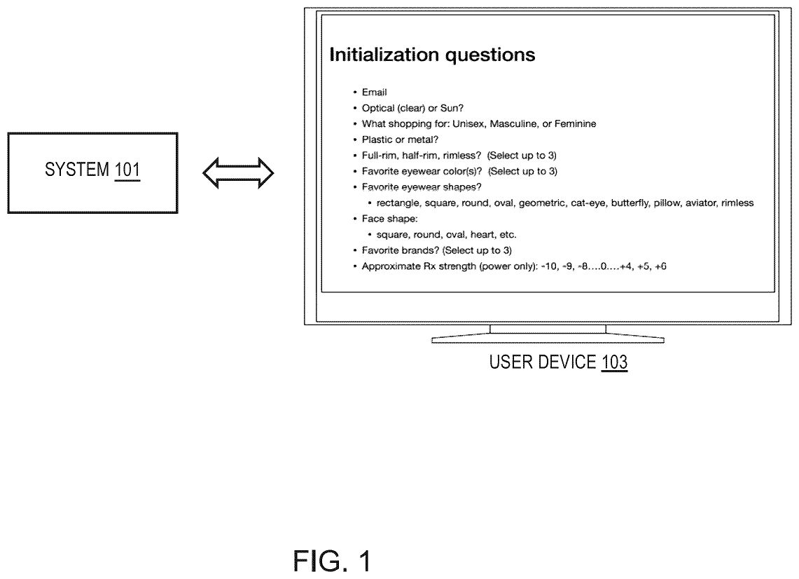

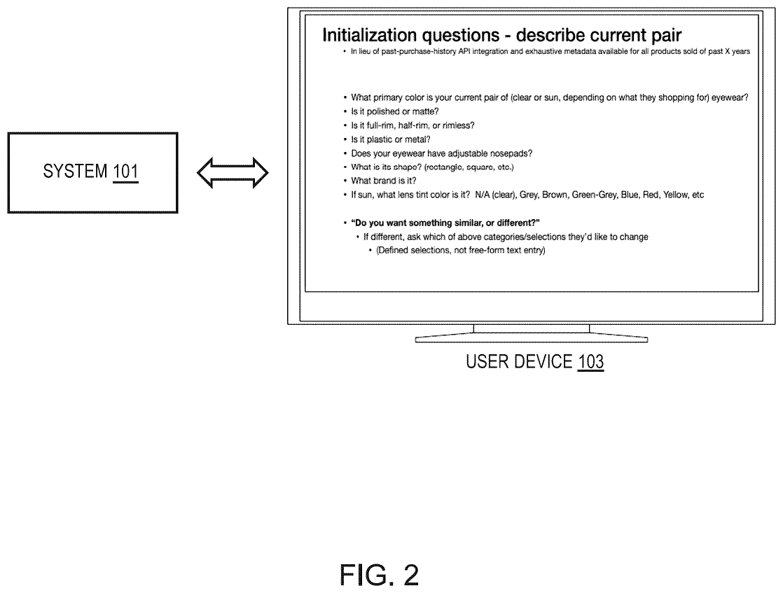

FIGS. 1 and 2 depict a system 101 for inferring user preferences and recommending eyewear according to aspects of the present disclosure. As shown, system 101 may infer depth information from standard RGB images using deep learning methods. This may eliminate the need for dedicated depth sensors, making the system accessible across a wide range of consumer devices. By extracting spatial information from conventional images, the system 101 may reconstruct a three-dimensional model of the user's face, accurately mapping contours, proportions, and structural details. To further refine the precision of these reconstructions, the system 101 may utilize reference objects of known size, ensuring proper scaling even in the absence of depth-sensing hardware.

Beyond physical fit, the system 101 may enhance recommendations by analyzing eye movements and gaze fixation patterns. By tracking where a user naturally looks, the system 101 may determine optimal lens positioning and frame alignment, preventing issues such as off-axis distortions or discomfort during prolonged wear. This integration of biometric and visual behavior analytics may allow for an intelligent, data-driven approach to eyewear and/or lens selection, making the experience both seamless and highly customized. By combining facial structure modeling with behavioral insights, the system 101 may redefine the process of finding the perfect pair of glasses and/or lenses, offering users a level of precision and personalization previously unattainable through conventional means.

The system 101 may be configured to initiate an interactive onboarding process on the user devices (e.g., user device 103), presenting a series of initialization questions designed to gather relevant user preferences (e.g., FIGS. 1 and 2). These questions may include, but are not limited to, inquiries about the user's email, optical prescription or subscription preferences, and specific shopping intent, such as whether they are looking for a full-rim, half-rim, or rimless frame. Additionally, the system 101 may ask about preferred eyewear colors, favored frame shapes, and other stylistic or functional preferences. The exact set of questions presented can vary dynamically, with the system 101 adapting its queries based on prior responses, inferred user behaviors, or contextual factors. While some users may receive only a subset of these questions, others may be prompted with an expanded set to extract deeper insights that may enhance the accuracy of the recommendation algorithm. Conversely, in some cases, the system 101 may opt to forego explicit questioning entirely, relying instead on implicit data signals, such as browsing patterns or previous purchases, to infer user preferences. This flexible, adaptive questioning mechanism may ensure that the system 101 gathers the most relevant information while maintaining a seamless and engaging user experience.

Multiple VTO images, scrubbable images/videos, generatively-generated images/videos, 3D renders or interactive 3D avatars, etc. (henceforth all variants referred to as images) can be displayed in a number of ways to illicit a response from the user: one at a time, two head-to-head, a multi-up (aka 4-up), etc. A customer could be asked to select which one(s) they like, and/or which one(s) they do not like, and/or if they like both (or all), and/or if they like neither (or none at all). They can up-vote or down-vote images by tapping/selecting the image(s), or tapping a button near each image, or swiping in a certain direction said image(s), etc. These series of actions are essentially binary choices—you either like or dislike what you see, optionally indicating a preference over an alternative presented. Why you like/dislike a given image can be asked, though every time a system asks a question or asks the user to think harder than a quick gut reaction introduces delay and friction—instead, ideally such a system should display head-to-head (or other variant matchups discussed previously) quickly enough that a large number of “votes” (user interactions that provide the system feedback) can be collected in such a way that the experience is fast, fun, and “gamified” in the minimum amount of time and ideally with the least number of votes required to obtain the information necessary to provide actionable and accurate insight and value. Even though the system may not know precisely why an image was preferred over another, there is a large amount of metadata, frame attributes, and other characteristics contained in each rendered image such that once a large number of head-to-head matchups are displayed and voted upon, implicit preferences for each set of attributes can be determined. This type of analysis can be a variant of discrete choice modeling.

More powerful, but involving more friction, is to perform a version of conjoint analysis to determine the strength of the preference for a given attribute or combination of attributes. Instead of a binary choice between two images, the system can ask the user to, for example, rank or score each of the two images (e.g. on a scale of 1-5). This way, if neither of the two are particularly well liked, the score will reveal this fact. Also, in a scenario where both images are liked (or disliked) the same amount, the scoring of each the same amount will reveal this fact.

If a particular image was downvoted (aka lost to a different image), the system could prompt the user to indicate which attribute of series of attributes is the attribute they liked least. The inverse can be performed for the winning image—which attribute(s) did they like best, and optionally the user can be asked to put answers in ranked order. In either case, it is a way for the system to more-directly tease out which attribute amongst many is most loved/hated from an image, which will serve to reduce the overall number of head-to-head votes that must be acquired in order to make meaningful conclusions on implicit preferences.

It is also important for the system to allow a user to skip, or opt-out, of voting on a given head-to-head. This is because when presented two images that a user dislikes, it can be cognitively taxing and slow to reason out which one to say he/she likes more. Choosing amongst two bad options generates a negative emotion, makes the experience less enjoyable, and slows down the flow. Rather, by enabling the user to skip, or to indicate their dislike of both options, it will then present two new options from which to choose from, moving things along and keeping the experienced gamified and light. The same can be true of two frames the user really likes. They could spend time trying to parse small differences to determine which one of two good options they like a little better. Instead, a system could also allow the user to say they like both, and keep things moving. There is important information contained in “like both” or “like neither” that a simple “skip” does not necessary tell a system one way or the other.

Though use of a technique known to those in the art called Design of Experiments, one can reduce the number of head-to-head VTOs needing to be displayed (and voted upon) before meaningful results can be statistically tabulated for each frame attribute. Such a technique can also assist with analysis of metadata that is not continuous, but comes in increments or is not numeric.

Often certain frame attributes are rare across an entire frame catalog. For example, if looking across a catalog of 1000 frames, very few will be green. As such, if a green frame is shown, it might be preferable for the system to weigh the results of a green upvote/downvote more strongly than others, since the likelihood of seeing another green frame is low (unless the next head-to-heads are dynamically responsive to previous votes). As such, for each attribute, weights can be assigned that are proportional to the frequency of which each attribute appears in a given catalog assortment. This proportionality can be based on frequency across the entire catalog (regardless of the subset of the catalog that actually fits the user).

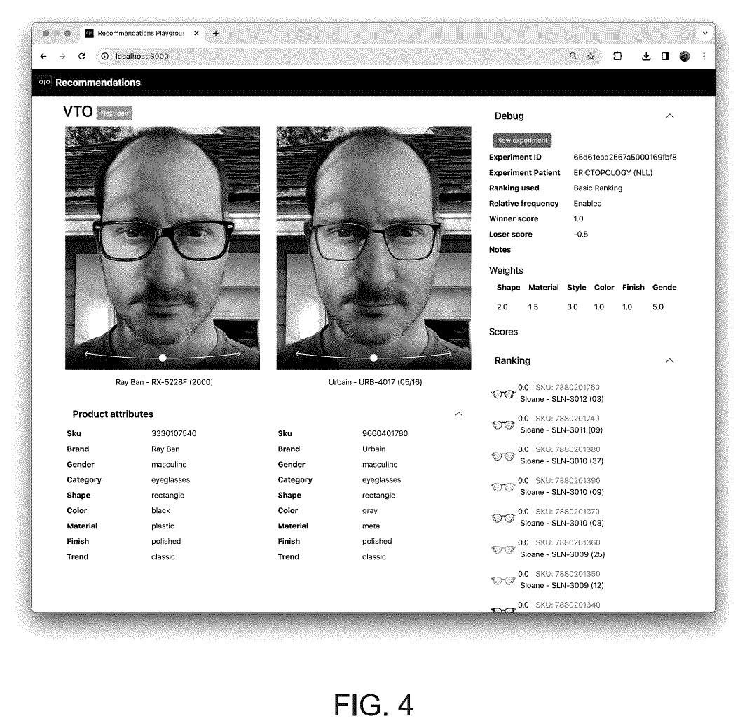

FIG. 4 illustrates a user interface designed to present an initial selection of eyewear frames, either through a randomized assortment or a carefully curated set of contrasting styles. The system may intelligently determine the best approach based on available user data, such as previously provided preferences, facial structure analysis, or historical shopping behavior. In some cases, the system may generate a diverse array of frames that vary in shape, rim style, and material to encourage user exploration. Alternatively, it may strategically present opposing frame style, such as a bold, thick-rimmed option versus a sleek, rimless design, to help user refine their aesthetic preferences. This selection process may adapt dynamically, incorporating real-time interactions, such as which frames the user engages with or dismisses, to further tailor subsequent recommendations.

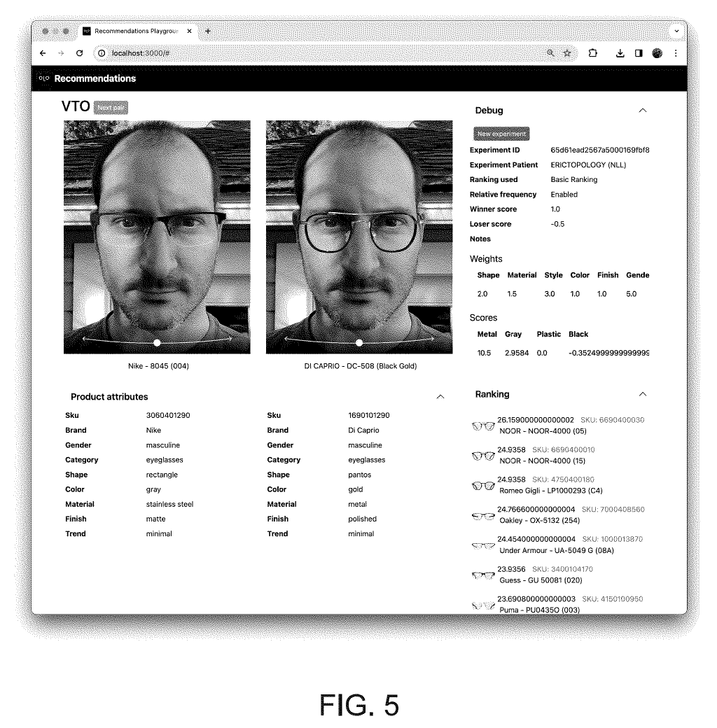

FIG. 5 illustrates a user interface that presents a real-time and/or final personalized ranking of eyewear frames, generated during or after an in-depth analysis of multiple factors, including frame characteristics, facial fit, and user preferences. The system may evaluate how each frame aligns with the user's facial structure, leveraging advanced face-mesh analysis, depth estimation, and/or historical preference data to determine an optimal fit. Additionally, the ranking may incorporate direct user input, such as votes or reactions given during head-to-head comparisons of different frames. In cases where the user has engaged with multiple options, the system may weigh factors such as engagement duration, selection frequency, and/or adjustments made to virtual try-ons. The resulting ranked list highlights the most suitable frames, allowing the user to make an informed decision with confidence. By synthesizing algorithmic analysis and user feedback, the system ensures that the current or final recommendations are both data-driven and personalized to the user's unique style and vision needs.

After a certain number of head-to-head votes, the system could optionally transition into a dynamic mode in which the next head-to-head display may be based on the results of the prior votes in order to better tease out the preference ranking for attributes that as of this moment are tied.

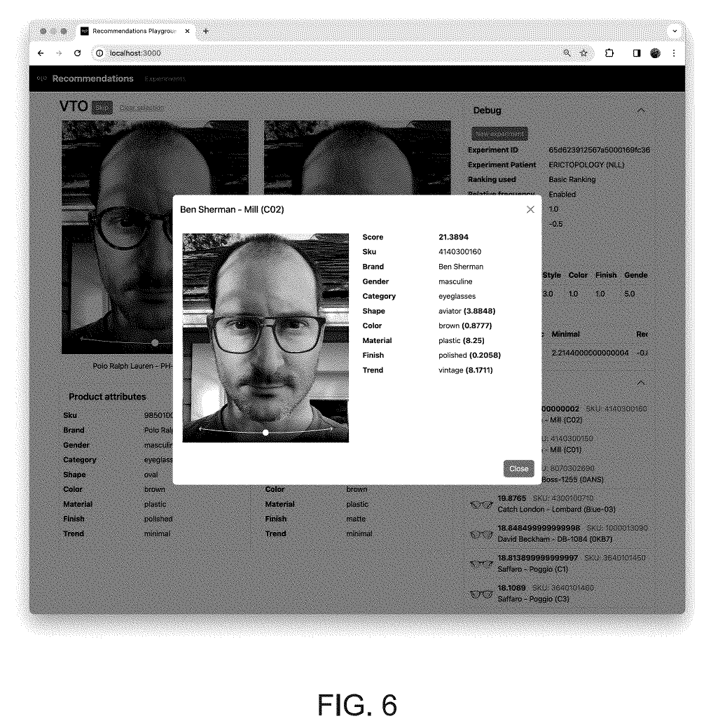

FIG. 6 illustrates a user interface that enables users to interactively explore their ranked eyewear options by selecting any frame from the list for a detailed virtual try-on experience. Upon clicking a frame, the system may overlay the selected eyewear onto the user's live or pre-captured image, allowing real-time visualization of fit, style, and proportionality. In addition to the virtual preview, the interface may provide an in-depth breakdown of the score assigned to the frame, explaining how various factors, such as facial alignment, lens compatibility, user preferences, and aesthetical appeal, contributed to its ranking. This transparency may allow users to understand why certain frames were recommended, and may allow users to make adjustments based on personal preference. By combining interactive visualization with data-driven insight, the system may enhance user confidence in their eyewear selection.

It may be preferable to intentionally introduce some randomness, pseudo-randomness, counter-intuitive backpedaling, etc into the dynamic mode of the recommendation experience, so as to ensure the resulting scoring of all frames (conclusions of a recommendation experience) are not stuck in a local minima. Such methods to ensure prevention of local minima are known to those in the art of algorithms and optimization strategies.

After each vote, all SKUs within a SKU assortment may optionally have their scores re-calculated in real-time. Or such recalculation can be delayed until a later time for performance and/or other reasons.

The system should keep a tabulation of each SKUs score, and update it after every head-to-head. For example, if a brown square frame wins (is chosen by a user) over a round blue frame, AND it is determined (either ahead of time or dynamically) that color (the attribute by itself, or the color brown specifically) is twice as important than frame shape to a user, then for example all SKUs that are brown get 2 points added to their score, and all SKUs that are square get 1 point added to their score. All frames that are round get 1 point subtracted from their score, and all blue frames get 2 points subtracted from their score. This example only discusses frames with two attributes, but in reality each frame has 10+ attributes, and each attribute can have its own pre-determined or dynamic weights applied. Weights can be static or dynamic, and applied to a category of attributes (e.g. “color”, or “shape”), as well as to the individual attributes in that category (e.g. black, or round).

It may be desirable to apply asymmetry to winning and losing weights, and such asymmetry may be different for different categories of attributes or specific attributes. For example, when a frame loses, it could be due to any number of attributes/reasons, and as such perhaps any frames that match the attributes of the losing frame should not be penalized by the same degree as if a dislike of an attribute were known with certainty. So if we take the above example, and we determine that any losing attribute should only negatively affect matching frames 50% that of a winning attribute, the winning frames remain unchanged from above, but the losing round frames instead lose 0.5 points from their individually-tabulated scores, and the losing blue frames lose 1 point from their individually-tabulated scores (both 50% less than before). And there can be a global asymmetric weighting applied to each attribute or category of attributes based on a win or a loss (or a tie, or a neither, or a skip).

As mentioned previously, certain attributes may be quite rare across a catalog. If the starting of this head-to-head experience were random pairings, the likelihood that a green frame will be shown in the first X matchups (for example X=10 or 20) will be low. As such, it might be desirable to ensure the first 10-20 matchups are selected in a pseudo-random or deterministic fashion—that is to say, pairings are systematically selected such that most, if not all, possible attributes across all categories of attributes, are shown in the first X head-to-head matchups. That way most categories have been shown, and most if not all attributes within each category are shown, and as such prior to switching to a “dynamic” mode, a proper “bolus” of data has been acquired. This also helps to ensure the experience is not path-dependent (a scenario in which results at the end are highly-determined by randomness).

Such a deterministic pairing, also called “structured-pairing,” in which desired attributes are intentionally selected to be compared in a head-to-head in the first X number of pairings, can have specific frame(s) SKUs shown (perhaps the most popular SKUs), or alternatively the system can pick a random frame from those frames that match the desired attributes of a deterministic pairing. One could intentionally want those initial SKUs that are shown to be those that are also top-selling SKUs (or more likely to be top-selling SKUs), and through a weighting schema applied to the algorithm that randomly, pseudo-randomly, or deterministically selects SKUs to compare one could achieve such an outcome. The order of such structured pairing, the number of structured pairings to be shown, the number of repeats of the order, etc can also be configured in the system. The system can be setup to be extremely configurable in its varied behavior in terms of what is shown, and how results of each vote apply to every frame based on the numerous frame or fitting attributes supplied or calculated.

In such structured pairing mode, those frames shown can intentionally have varying degrees of differences in attributes allowed. Based on configuration, only one difference amongst two frames at any given time could be shown. For example, two identical frames in shape, material, size, etc are shown, except one is brown and the other blue. In essence, if all but color were held constant, they would be two different SKUs of the same frame geometry from the same manufacturer. But in reality, some frames only come in one color, so even if differences were to be minimalized, the system should have some allowable amount of deviation for each attribute, and such allowable deviation can be different for each category of attributes or individual attributes, especially for attributes with continuous values—for example the A (width) of the frame, which can vary by a tenth of a millimeter across frames, and a 0.1 mm difference in A between two otherwise identical frames is essentially undetectable to a user.

The downside of holding all but one difference constant across two (or more) frames, even allowing for some small deviation in attributes, is that there are less frames available to be shown that match a given criterion. If there are zero pairs (or triples, etc) to be shown, such a structured pair could be skipped being shown, or some amount of fallback increased deviation could be allowed until there is at least one viable pair to be shown. Alternatively, allowing at least two noticeable deviations does allow for more pairs to be available to be shown, but then more than one change is being judged by a user. This can be beneficial in that more information is being displayed to, (and gleaned from) the user in each vote, but the more differences the more difficult it may be for a user to make a choice, and the more difficult it is for a system to understand the why behind each choice.

It is also desirable for a system to be able to be configured to ensure repeat pairings are not shown, as this can be frustrating to a user (aka “I already answered this question”) and only prolongs the experience. However, sometimes users are inconsistent in their actions, and it may be desirable to test their consistency by showing a pairing of different frame(s) again that tests a given hypothesis in order to confirm such preference consistency, and/or to intuit the strength of such a preference or preferences.

In some instances, such as color, there are many available attributes within an attribute category. It may be preferable to sub-categorize attributes under a given attribute category in order to reduce the number of attributes to be tested. In the example of color, it might be worthwhile to create sub-categories of color such as “common colors” (e.g. black, brown), “medium rare colors” (e.g. blue, clear, etc), and “distinctive rare colors” (e.g. red, green, etc). Similar categorizations could be applied to metal colors, or combinations of color and surface finish, etc. In such an example, the system can test these subcategories (allowing for any frame with a color within the subcategory to be shown), and the resulting upvote or downvote of the pairing could affect the scoring applied to the sub-category, which could affect (similarly or differently) all colors within that category.

It may also be desirable to avoid showing outlier frames in any given pairing. For example, after analysis of all frames (that optionally pass fitting) of a given user, and assessing the distribution of all attributes of all frames, there may be outliers within a given category of attributes, and it may be desirable to avoid showing such outliers as their extreme nature may bias a user in their vote. For example, in the case of width, it might be preferable to avoid showing a frame that has maximum or minimum values. If width were bucketed into say 5 categories of width, it might be desirable to only show frames that are in the 2^{nd} and 4^{th} buckets, ensuring there is a significant enough difference between two head-to-head frames for the user to perceive (and thus ensuring system has valuable information contained within a vote to take suitable action on that category), but doing so ensures that an extreme width is not shown that could bias a vote and distort the conclusion from such a signal. Optionally, in such an example, if the wider 4^{th} bucket were constantly (or often) chosen over time over the smaller 2^{nd} bucket of width, the system may intuit that larger frames are more desirable over smaller frames, and it may no only also increase the scoring of frames within the 4^{th} bucket (and decrease the scoring of frames in the 2^{nd} bucket), but also increase the scoring in those frames larger and smaller than the buckets shown (optionally with a less strong affect). Frames in the 3^{rd} bucket may or may not have their scoring affected in a positive or negative manner, depending on the desired configuration of the system

A scoring algorithm could also take into account the sell-in or sell-through performance of SKUs in how final scorings are calculated. Or alternatively, those that are top-selling (or the inverse and those that are not selling) can have their scores boosted after-the-fact to achieve a desired business outcome.

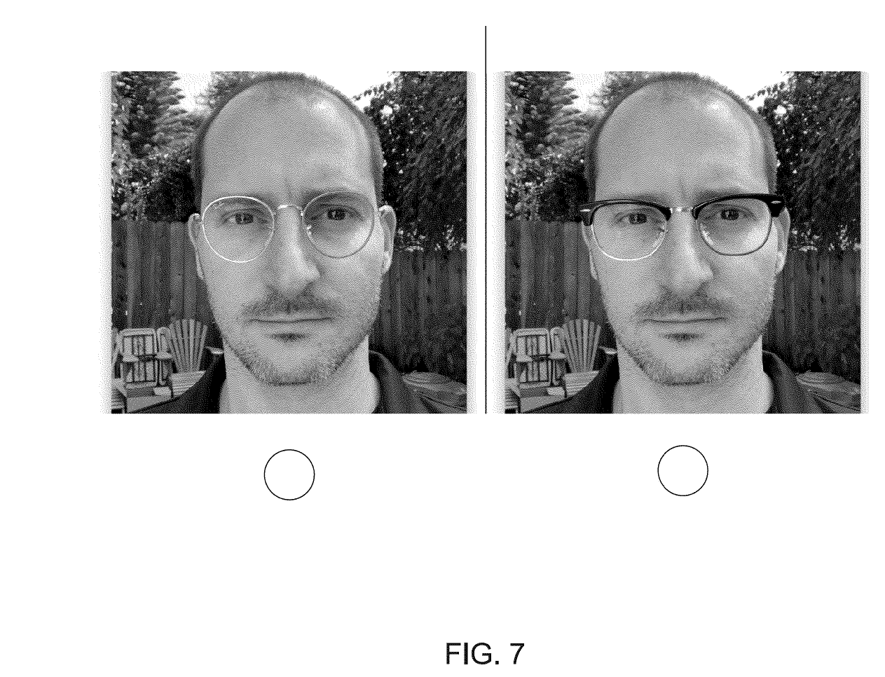

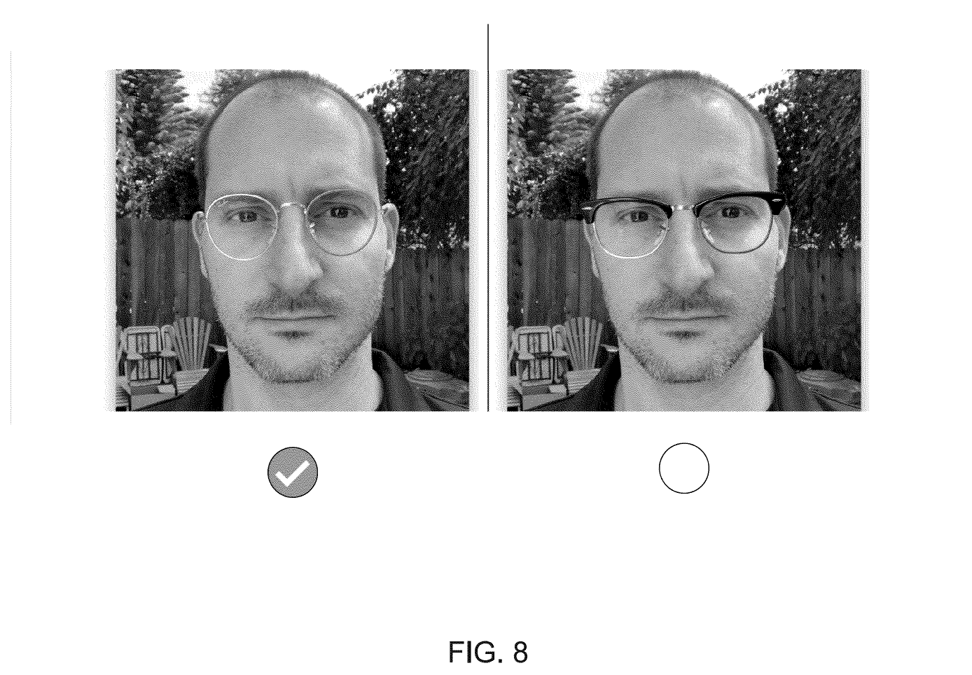

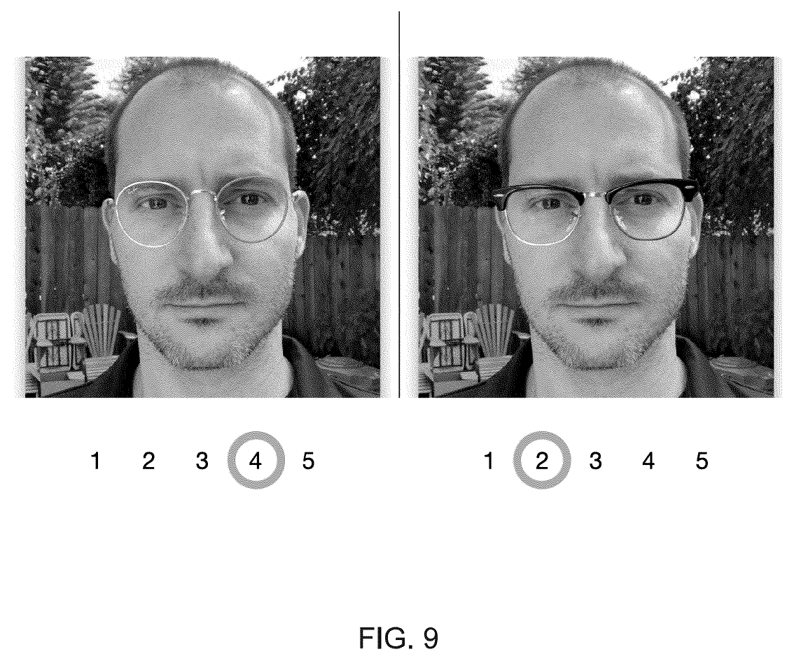

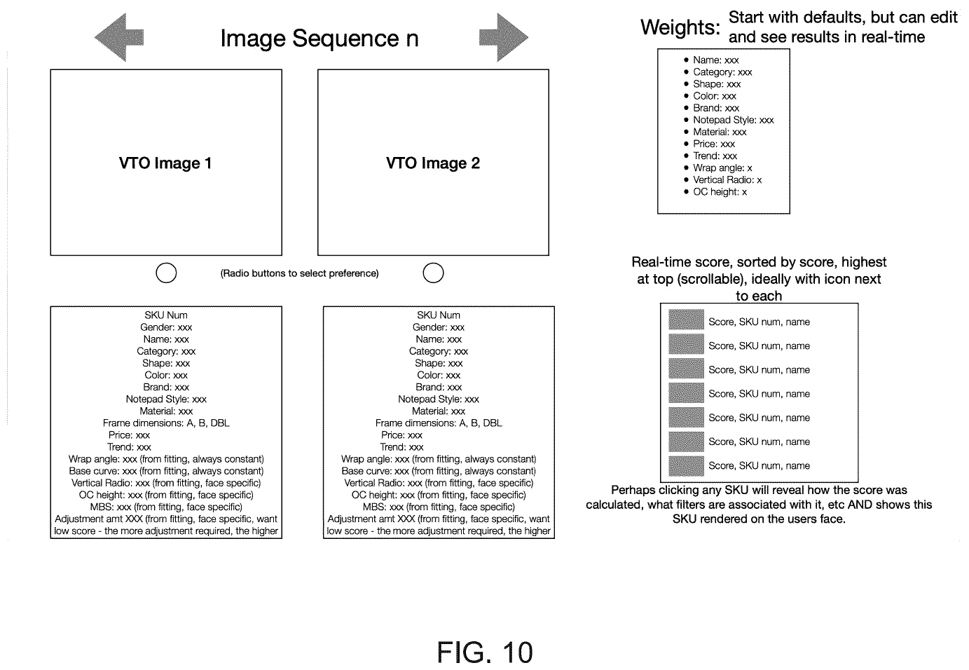

FIGS. 7-10 illustrates a VTO interface that may allow the users to compare two different styles of frame in real-time, providing side-by-side, head-to-head visualization. This feature may enhance the shopping experience by offering a lifelike preview of how each frame appears on the user's face, leveraging advanced facial tracking and alignment technologies to ensure accurate positioning. The users can seamlessly switch between frames, adjust angles, and observe subtle differences in fit, shape, and aesthetics. Additionally, the interface may incorporate interactive elements, such as user voting or preference selection, enabling them to choose their favorite option with confidence. By providing a direct, real-time comparison, the system helps users make informed decisions while streamlining the selection process.

In order to pre-initialize a recommendations head-to-head VTO experience best suited to a customer and his/her needs/desires, it may be preferable to ask as few questions as possible up-front, or optionally interspersed within the experience (ask some questions up-front, refine what will be shown based on answers, then show some head-to-head VTOs and get some votes, then ask a few more questions and refine the next head-to-heads based on answers, etc). By not asking a large number of questions upfront, a system can better engage the customer by getting into the visual head-to-head part of the experience sooner. Once the user is more engaged, it can pause to ask another question (or series of questions). The answers to each question could affect the next pairings to be shown, or held and then leveraged later in a dynamic pairing mode.

Various integrations with a retailer's backend can help to reduce the number of questions that may be asked upfront. For example, without any integrations, it may be preferable to ask the user if he/she is shopping for male, female, kids, and/or unisex, but a backend integration with a CRM or EMR could negate the need to ask such a question because age and gender are likely contained in a customer's record and such information can be leveraged.

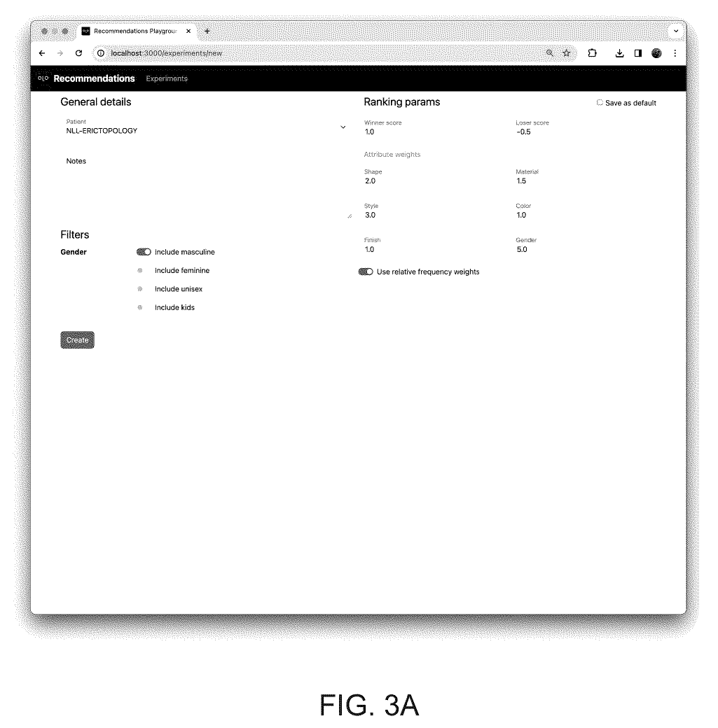

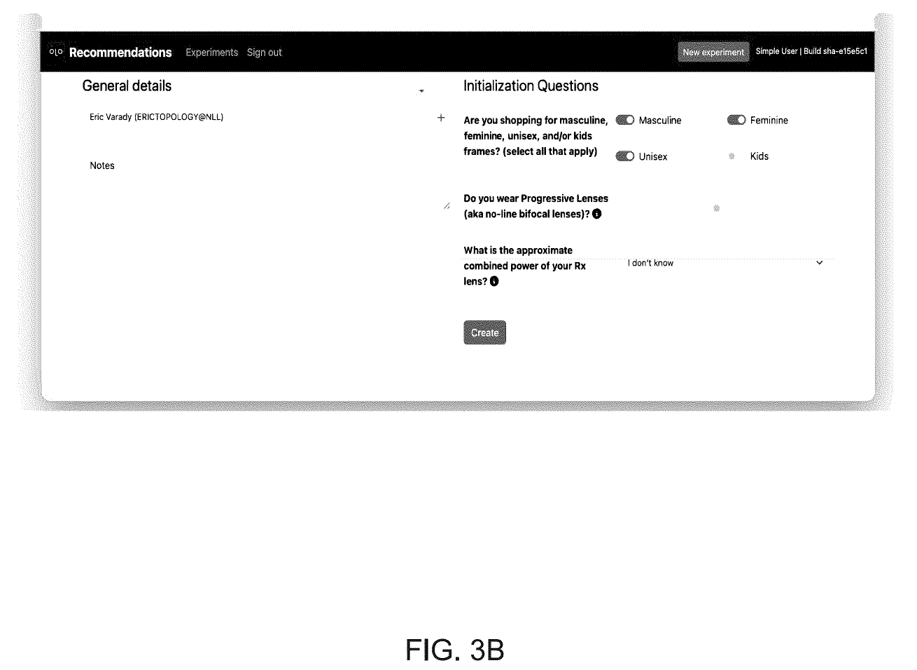

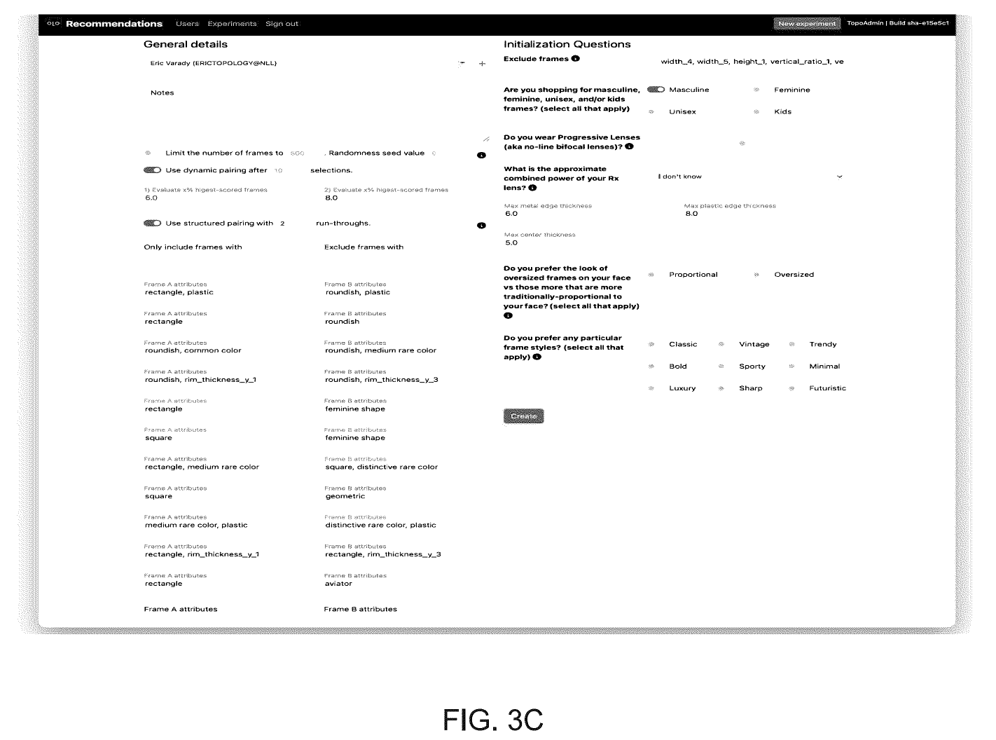

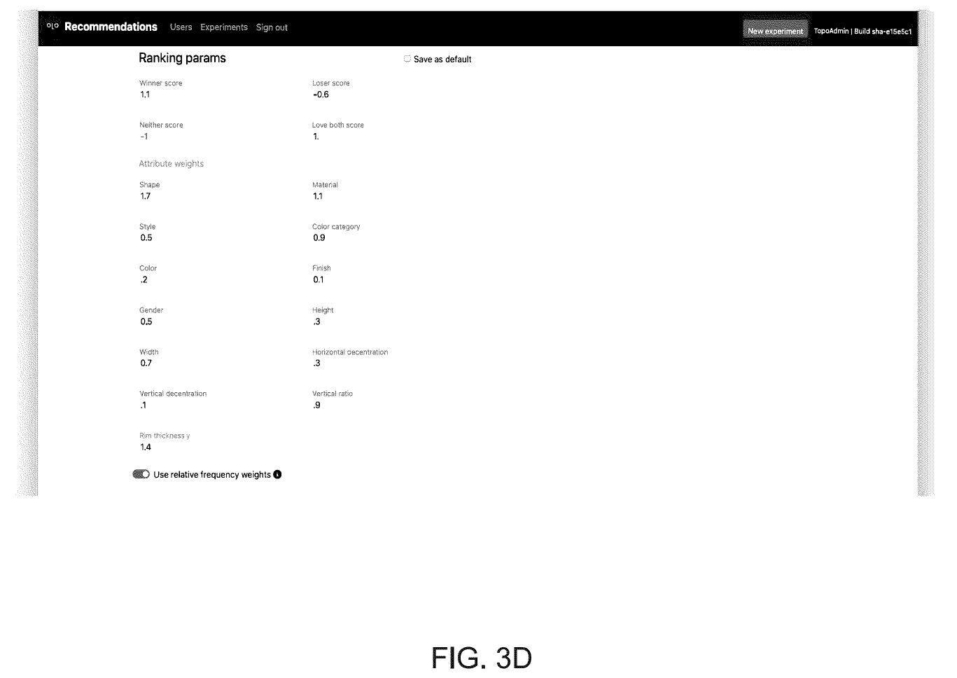

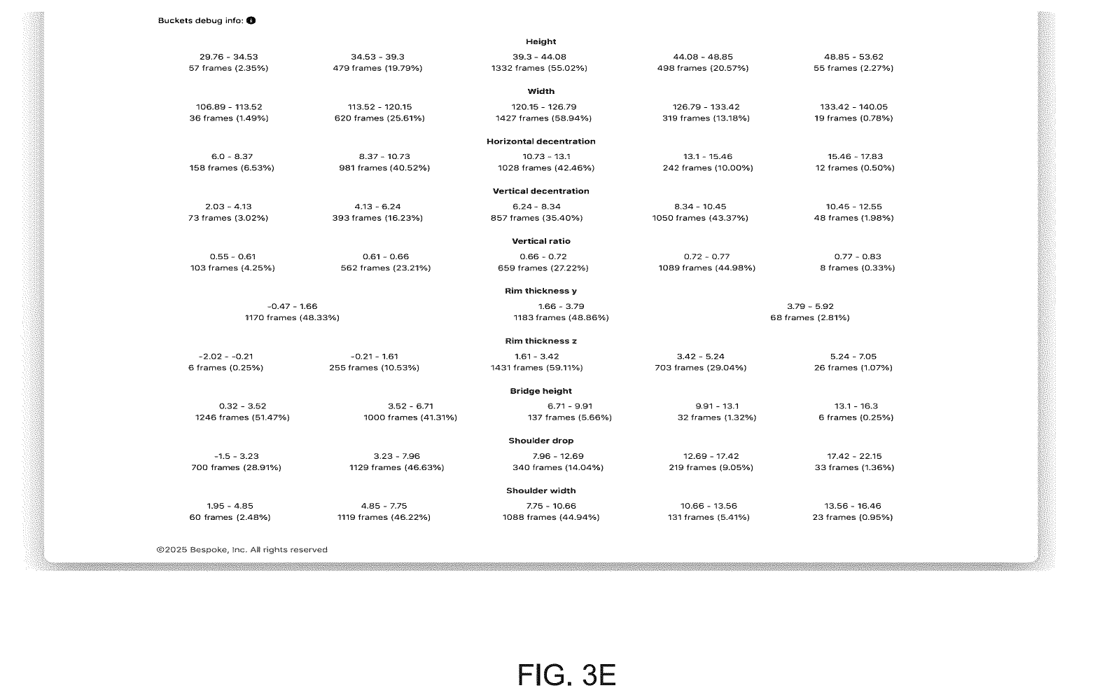

In one instance, FIGS. 3A-3H illustrate user interfaces generated by the system for capturing gender and vision-related metadata, which may play a crucial role in refining eyewear recommendations. These interfaces, displayed on the user device (e.g., user device 103) may present a sequence of interactive questions designed to gather essential optical and preference-based inputs. The system may ask whether the user is shopping for masculine, feminine, or gender-neutral eyewear styles, helping to tailor frame suggestions accordingly. Additionally, the interface may prompt users for information about their prescription types, such as whether they wear progressive lenses, single-vision lenses, or reading glasses. To further refine optical recommendations, the system may inquire about the combined power of the user's lenses (or more simplistic or specific detail about nature of their Rx and vision needs), ensuring that frame compatibility is optimized for thicker or more specialized lens types. The specific sequence and number of questions presented may vary based on prior responses and desired UI/UX, and may dynamically adjust to collect only the most relevant data. By structuring the onboarding experience through intuitive and/or adaptive user interfaces, the system may enhance its ability to deliver highly personalized eyewear recommendations.

FIG. 3B illustrates a simplified debug interface that can streamline the eyewear recommendation process by hiding or exposing complex confirmation settings from users with restricted access. Instead of exposing all system behaviors, the interface displays only a subset of configurable options relevant to the eyewear selection. This ensures that users can fine-tune recommendations without altering critical backend algorithms, maintaining system integrity while enhancing user experience.

FIG. 3C illustrates a highly configurable debug interface for a recommendation algorithm that may provide granular control over numerous adjustment parameters, allowing for fine-tuning of the system's behavior. The example screen displays a subset of these configurations, enabling users to modify key aspects such as weightings for explicit or implicit user preferences, frame fit tolerances, lens enhancement factors, etc. While advanced settings remain accessible for expert users, the structured layout ensures clarity, facilitating efficient debugging and optimization of the eyewear recommendation process. It also provides a structured yet flexible framework for configuring the eyewear recommendation system. It displays limits on if and when to transition from structured pairing to dynamic mode (or to skip structured pairing and/or dynamic modes entirely), ensuring optimal adaptability. Users can define the order of structured pairings and specify which attributes to internally test in head-to-head comparisons. Additionally, the interface allows for configuring permissible deviations for non-described attributes, including the degree of variation allowed for each considered pairing. Outlier attributes can be excluded from the display to refine the user experience. Initialization settings may include user-specific questions, a configurable threshold for minimum OC/Seg height, and any known biases in size or trend, which can be displayed and adjusted accordingly to enhance recommendation accuracy.

FIG. 3D illustrates an example screen of a highly configurable debug interface that provides advanced control over numerous adjustments within the recommendation algorithm. It displays a structured subset of configurable options, allowing users to fine-tune key parameters, such as ranking and weighting parameters. The user interface also provides a comprehensive view of ranking and weighting parameters, allowing users to configure score-weighting strategies with flexibility. It enables adjustments to the influence of various attributes within the recommendation algorithm, ensuring tailored rankings. Additionally, the interface includes options to modify the effect of weighting strategies based on attribute frequency, dynamically increasing or decreasing their impact depending on whether an attribute is rare or common. This level of configurability may enhance the precision of recommendations while maintaining adaptability to diverse user preferences.

FIG. 3E illustrates an example screen of a highly configurable debug interface that presents a structured view for fine-tuning numerous adjustments within the recommendation algorithm. It allows users to modify key parameters, such as height, width, horizontal and vertical decentration, vertical ratio, rim thickness, bridge height, shoulder drop, and shoulder width. While only a subset of the full range of configurable options is displayed, the interface provides precise control over frame fitting and recommendation logic. The user interface also displays a subset of individualized bucketing strategies for various continuous attributes, distinguishing between frame-specific attributes (which do not depend on fitting) and those derived from virtualized or simulated fitting to an individual's face. For a given catalog and facial profile, it shows the number of frame SKUs that pass the fitting criteria and are available for recommendation based on each attribute shown. Users can configure a subset of these attributes bucketing strategies to normalize results or dynamically adjust bucket sizes to maintain a balanced distribution of frames across buckets, ensuring a more consistent and optimized recommendation experience. Use of virtualized eyewear fitting against a customer's 3D reconstructed face in recommendations enhances the value of the recommendations, but this is optional.

In one instance, width measurements may be based on different calculations, such as lens' A, or (2× the lens' A)+DBL, or (2× the lens' A)+DBL+2× the frame's shoulder width. Additionally, the interface supports calculation for horizontal decentration of the pupil from the geometric center (in mm), vertical decentration of the pupil from the geometric center (in mm), and vertical decentration of the pupil from geometric center in terms of a ratio of the B (height) of the lens. Other configurable parameters include the vertical distance from the top of the top of the A (or top of the A+frame rim thickness at the top) to the top of the temple where it meets the front plane of the frame front. As well as the horizontal distance from the outside of the lens (optionally inclusive of rim thickness) to the outermost point on the frame front. These advanced configurations ensure precise fitting and optimization of the recommendation experience.

Another example of a valuable question to ask users is “are you shopping for something similar to your last pair of eyewear, or something different?”. But to understand what was purchased previously, and in order to initialize a recommendation experience with head-to-head VTOs relevant to this answer, it may be desirable after asking this question for the user to describe the attributes of his/her last pair of eyewear. For example, the system may ask the user to describe the shape, style, material, nosepad style, color, etc. of their current pair of eyewear. If the user wants something similar in their next pair of eyewear, then the system initialize in such a way as to show head-to-head images with attributes similar to the described last pair of eyewear. In other words, the scores of all SKUs may not start at zero, but instead be pre-initialized with values such that similar frames to the last pair begin with a higher score initially than those frames that are significantly different—in this way similar frames are shown first (and are likely to end up with a higher score), but if the system infers from a user's votes that the user's implicit preferences are more aligned with frames that are different, eventually frames that are different will achieve higher scores and may be recommended at the end of the experience.

If the user asks for something different, the experience can better be initialized if the user is asked precisely what categories of attributes, or specific attributes within these categories, do they wish were different. Such information can be acquired by giving the user a set of attributes, or categories of attributes, to select from that allow them to express what they want different (e.g. color, shape, etc.). The user may optionally select one item, or multiple items, or multiple items in ranked order. Alternatively, a freeform text box could be provided and the user can describe in the language of their choice what they desire, are shopping for, etc., and the system can use various methods known to those in the art to understand said text and pre-initialize the system based on the response.

Additionally, a system could accept a picture of the user wearing their last pair of glasses, or a picture of a pair of glasses held-in-hand or on a table (or a whitebox photo), and using AI techniques known to those in the art and large language models that can interpret images, the system could automatically extract all metadata associated with said picture automatically. In this way, an UX can be more streamlined, and it can ensure consistency in the formatting of such metadata.

Another way to avoid asking the user to describe their last pair of eyewear is to enable a backend integration with a point of sale system, CRM, customer database, etc. in order to access the desired information automatically. There are other backend integrations similar to the above that can further negate the need for asking the customer questions in order to streamline the flow, reduce the number of questions, make the head-to-head VTOs initially more relevant, and reduce the number votes necessary to return personalized recommendations and results.

During a head-to-head VTO experience, if a user sees a frame they absolutely love, the system may allow for a buy-it-now button.

The system may use various AI techniques to leverage the information at the system's disposal to better initialize the system and make the initial and subsequent head-to-heads more relevant. Such AI systems may leverage attributes of the customer's face (face shape, nose shape, head size, skin color, eye color, hair color, hair style, hair length, cheek structure, ear position, age, gender, location, ethnicity, Rx, lens designs, lens coatings, jewelry, makeup, etc.). Such an AI system can also leverage a picture of the customer with clothing visible in order to make a determination of the customer's style (and then recommend frames that match such a style). Such a system can also use look-alike techniques to find faces similar to the customer, and leverage the purchase history not only of the customer using the system, but also leverage the recommendation results and purchase-history of similar client profiles (leveraging the face or not, all while maintaining customer privacy), in order to provide better recommendations with less customer input.

After a large number of faces are scanned, and after a large number of customers have gone through the recommendation experience (each experience collecting many votes against frames with many attributes), an AI system can be trained in order to predict preferences of a user without any need for customer input (leveraging all information known about the user via system integrations, as well as AI analysis of the face). Once such preferences are known, personalized and effective recommendations can be provided—solving the “cold start” problem of providing recommendations to users who have not gone through the head-to-head VTO experience.

How many head-to-head VTOs are shown to the user may be a fixed number, dynamic based on the results and distribution of the SKU scoring and/or sorting, or continue indefinitely. The system may allow the user to end the experience at any time, and those frames at that moment that have scored the highest are those ultimately recommended. It is up to the retailer/e-tailer how to leverage the outputs of such an experience. They may decide to show a limited number of those frames that have the highest score. However, since all frames have been scored, the results may show all frames in inventory, sorted by score.

Such an experience may decide to group various non-continuous or continuous attributes together in order to ensure the combined attributes are of sufficient quantity or distribution to be leveraged in such an experience. For example, the system may combine various types of metal (stainless steel, titanium, etc.) all under the attribute “metal”. Or various types of plastic (acetate, TR-90, polycarbonate, etc.) under the attribute “plastic”. Or ranges of a continuous measurement such as width into distinct “buckets” that can have the minimum and maximum values, and discrete intervals based on the min and max values of all the frames under consideration, or have outliers removed, or other strategies. Furthermore, the ranges that map to each bucket can be fixed and have even regular widths, or they can have dynamic widths in order to ensure buckets have near-similar numbers of SKUs present in each range.

The system may optionally watch the user as he/she interacts with the recommendation experience, and read the facial expressions/emotions of the user as he/she see images, and then infer responses based on what the system observes. The system could optionally monitor heart rate, blood flow, and gaze to also determine reactions. Optionally, it may not even ask the user to physically “vote” on what they see—it can just cycle through images quickly and read the preferences of the user based on what it observes of the user. This can work based on a single VTO image displayed, or head-to-head (looking optionally at the gaze of the user to determine the emotions of the user as they look at two or more VTO images displayed simultaneously).

The system may show head-to-head VTO's leveraging the retailer's inventory, and at the end of the experience (or when the customer terminates the experience) show the results of that inventory, but alternatively the system my leverage frames that are not carried and/or sold by the retailer, or not in-stock at the retailer, during the experience. Or it can be a hybrid of the two options just mentioned. The system may optionally determine to hide the “buy-it-now” button for any frame that is not carried, sold, or in-stock. Once the implicit preferences of the user are determined, the system may output various common measurements/attributes to the retailer so they can then score their inventory against some or all of these attributes (e.g. A, B, DBL, temple length, material, color, style, shape, etc.). AI can also be used to find similar frames in the retailer's inventory to those that scored highly in the recommendation experience (which used alternative inventory to power the experience). Alternatively, while the system may not have the specific inventory of a retail digitized for the purposes of the recommendation experience, the system can interrogate the retailer's systems for their specific SKU assortment (in-stock in a given store, and/or in-stock in their distribution facility, and/or available to be dropped-shipped directly from a distributor or manufacturer to the retailer or lab), and then it can do the mapping of customer preferences against such non-digitized frames at the retailer on behalf of the retailer/e-tailer, and then return the scored and sorted list back so the retailer/e-tailer can then customize the next part of the shopping experience regarding frames they actually do sell.

Various frame constructions, especially those with adjustable nosepads can be fit on the same face at different vertical positions, even at the same approximate distance from the eye. The nosepads can be adjusted narrow, causing the frame to sit higher on the face (and the eye lower within the lens), or the nosepads can be adjusted wide, causing the frame to sit lower with respect to the eye (and the eye higher within the lens). This variation in fit can be determined based on the system's understanding of aesthetic preferences, as well as other considerations such as avoiding cheek contact, Rx considerations (allowable decentration), how previously-voted on frames fit on the face, etc. Alternatively, the system could show in a VTO head-to-head the same frame on the face, but fit the frame in two different vertical positions (which can be achieved via two different nosepad adjustments). In this way, the implicit or explicit preferences of the user regarding where they like certain frame styles to fit on their face (often relative to their eyes and/or eyebrows) can be determined. For example, some customers may prefer certain frame styles to cover their eyebrows (or extend above their eyebrows), whereas for other styles they prefer the frame to sit below their eyebrows, and such a system can determine this preference to be applied to all frame styles, or only to certain frame styles.

Plastic frames cannot be adjusted to sit higher or lower on the face (other than minor adjustments to the temple length), but understanding the implicit or explicit preference of vertical decentration of the eyes, or how the top of the frame should extend at, above, or below the eyebrows, can also help to sort and rank plastic frames purely based on where they sit on the nose.

If a customer expresses a desire for lightweight eyewear (frame+lenses), either via a questions & answers, or via purchase history (opting for higher-index lenses, and/or minimized horizontal & vertical decentration), the system can preference (increase the score) of those frames that will minimize edge lens thickness (in any lens index), and thus weight. It can also preference those frames that leverage lighter-weight materials (e.g. titanium), or a frame that has overall lower weight. If weight of a frame is not known, the system can determine the approximate weight of the frame by multiplying the volume of the frame (known or approximated) by the frames' material density (known or approximated). The system can also advantage those frames that have a nosepad geometry that better matches the nose shape of the patient, as a better match ensures better weight distribution over a larger contact surface, which has been shown in prior art to reduce pressure points and complaints about comfort and weight. Additionally, various lens designs and materials that reduce weight (high index, aspheric, progressives with prism thinning or lenticular thinning, etc.) can also be recommended by the system.

The system may optionally decide to exclude certain frames from the experience based on the responses to certain questions asked of the user. For example, the system may ask if the user is shopping for optical frames (clear lenses), piano (non-Rx) sun, or Rx sun. If the customer is shopping for optical frames with clear lenses, then piano sun frames (or optical frames with tinted lenses) can be excluded from the experience, and/or the results returned, and/or it can score the “excluded” frames much lower. If the user is shopping for piano sun frames, then frames with clear lenses can be similarly excluded. If the customer is shopping for Rx sun, Rx-able piano sunglasses can be shown, but also optical frames can be shown—ideally rendered with tinted lenses. Depending on the strength of the customer's Rx, smaller optical frames with tinted Rx lenses may be scored higher because these frames can support smaller lenses, which in the strong Rx of the customer will minimize edge thickness and weight.

Additionally, depending on whether the customer is shopping for non-tinted or tinted lenses, the system may be configured to have different attribute weighing schema or other differences in these instances. For example, when shopping for tinted sun, the eyes are not visible, and thus the allowable horizontal pupil decentration may be relaxed. Furthermore, the bucketing behavior of various attributes may be changed, the types and order of structured pairing may be changed, etc.

If the customer's Rx (determined via responses to a question or questions about their Rx, or pulled via an integration with the retailer's EMR) is above a certain power threshold (e.g. stronger than −5.0 diopters), then frames with a wrap angle above a threshold (which can be dynamic in response to lens power, or set at a fixed threshold) can be excluded. The same logic can also be applied to frames that result in high pantoscopic angle, excluding those above a threshold that can be fixed, or dynamic based on the power of the Rx.

Brand affinity can also optionally be tested in a recommendation experience. A customer can be asked via a questionnaire what is his/her favorite brands (free-form entry, selectable list, top 3, etc). Based on those answers, eyewear of those brands can be preference by a higher weighting or scoring. Affinity for one brand can also be expressed as affinity for other brands—for example, affinity for certain high-fashion brands can be interpreted as a preference not only for that brand, but for other brands that are also considered high-fashion, edgy, trendy, etc, and thus the recommendation algorithm may also preference similar brands' products as well though similar or slightly different mechanisms. The customer need not explicitly answer a question to show affinity for a given brand in order for the algorithm to take action as described—their upvotes or downvotes can also implicit brand or trend affinity. Furthermore, certain brands may have distinctive logos or features, and a system optionally may choose whether or not such instances, if desired by the customer, imply preference for that brand alone or similar brands. The “TF” logo of Tom Ford, in which the “T” wraps around the side of the frame and is prominently shown on the front, is one example of a visible logo that is a design element that might be independent of other similar brands.

The degree of “scrub-ability” or “pan-ability” of the VTO (in which the user can interactively turn his/her head in the VTO, can be system or user configurable. Optionally, when a user turns his/her head in one displayed VTO, the other VTO can turn in-sync—that way when the user is looking at one side of their head (exposing the eyewear's temple design more clearly, they can also the the differences in the other VTO(s). The allowable amount, if any, of head turn yaw can also be optionally-configured, as well as when scrub-ability is allowed. The less scrub-ability allowed, the less data needs to be rendered and transferred to the user, and thus the lower the latency of the experience. Optionally, allowable scrub-ability could be delayed until later in the experience, once a narrowed set of frames is displayed. Or, if there are specifically two types of temple designs being compared, the system could automatically pans the head (statically and/or dynamically, and/or in animated form) in order to draw attention to these differences. When the VTO is not scrubbable, and is a static image, then any click/tap/or pan can optionally be interpreted as a selection/vote of the image, which simplifies the UX.

Certain votes can be asymmetric in their effect—the action (selection of the winning/preferred frame) can be interpreted by, and reflected in, the recommendation algorithm as only positive for the SKU (or similar SKUs) of the up-voted frame, or only negative for the downvoted (losing) frame (or similar frames).

There is high value in a resulting personalized rank-ordered scored list of the entire inventory of a retailer's SKUs for a given customer (with or without consideration of which SKUs fit a given user). Subsequent to the experience, various filters or questions can be asked of the user to further narrow which frames are being shopped for, and the results of such filtering can be displayed in order of the ranked (scored) preference ordering.

A recommendation experience can be optionally paused at any time, and the resulting scores of all SKUs stored. A user may return to the recommendation experience at a later date and optionally picked up where they left off. If there is a different SKU assortment available at this later date, a re-calculation of the scored list of frames now available (based on all votes the customer supplied earlier, even on SKUs no longer available) can be run against all SKUs now available (including those that are newly offered since the last use of the experience). Optionally, eyewear fitting can also be re-run on newly available SKUs, and optionally re-calculation of attribute bucketing could also be performed prior to re-running of scoring calculations based on prior votes. Furthermore, if conversion (purchasing data or history) by the user (or similar users, etc), or a different scan of the user, or other information that is available to the system that affects a scoring algorithm) is recently available since the last calculation of scoring, this too can be considered and applied to any re-calculation of scoring of all available SKUs.

In addition to a rank-ordered list of SKUs based on score that is returned to the client, a system can also return a rank-ordered list of preferred attributes based on score. For example, the system can inform the client or user which colors are most desirable in descending order of preference (e.g. black, then brown, then blue, etc), and/or which shapes are preferred in descending order of preference (e.g. rectangle, then round, then aviator, etc). The system can return an entire list of all attributes, much like it can return a list of all SKUs in a catalog, or only a subset (cut-off list) of either based on a pre-determined threshold for each.

### Leveraging Depth-from-Rgb Deep-Learning Approaches

This method describes leveraging depth-from-RGB deep-learning approaches to auto-calibrate (sensor fusion-align) depth sensor to RGB alignment by auto-aligning the depth image (from the depth sensor) to the depth map acquired via the AI depth-from-RGB analysis. This method is valuable in the case of no factory calibration, bad/faulty factory calibration, calibration out of date (due to time or thermal drift), if device dropped (and previous alignment/calibration no longer valid), etc.
a. Marigold is an example of one such depth-from-RGB techniques, but other techniques previously-developed, and those subsequently-developed, will be known to those knowledgeable in the art and can be used in this disclosed manner.
b. How to align RGB to the device's depth sensor:
   i. take a simultaneous RGB and depth capture of an object. Sharp features/points/edges (known to those knowledgeable in the art) are best leveraging for alignment given they can have single-pixel (and often sub-pixel) features that are easy to extract and align against. If the object imaged has a prior-known shape (such as a sphere, hemisphere, flat edges, etc), one can fit known-prior shapes to these features in the depth map extracted from RGB and the depth-capture from the depth sensor in order to better fit the two images against each other (helping to reduce noise inherent in the depth image). A ball is useful b/c it is common, the scale does not matter, and it aligns in all three dimensions: x, y, and z. But this technique is mainly concerned with X and Y.
   ii. But in the case of a face, where no sharp features are available, one can capture any face pose, though a frontal pose is best (thanks to the nose), and then use the nose to achieve such alignment. Taking a cross-section of the nose in both depth images (one from the depth sensor, one output from AI after depth estimation from the RGB image), one can align the cross-sectional profiles together to solve for the pixel offsets between the two.
c. After such analysis, the system can store the proper offset(s) and leverage them to auto-align subsequent RGBD captures, or a system can simply compare the resulting offsets against a set threshold—for those devices that exceed the threshold, the system could notify the user that the device is severely out-of-alignment and suggest getting the device serviced, use a different device, etc.

### Determine Eye Movements

The below embodiment describes a system that can determine eye center of rotation, and/or the eye radius, and/or the unique behavior of the person as they gaze at an object moving side-to-side and/or up-and-down—does he/she primarily tilt his/her head up/down and/or left/right to track the object (keeping eye movement minimized), or does he/she primarily move his/her eyes and keep his/her head fixed (or near fixed), or some hybrid or percentage of these two options. This embodiment also determines if a different ratio of head vs eye movement exists when vertical tracking of gaze vs horizontal tracking of gaze.

Any mention of depth sensor below can also be accomplished using pure RGB images once a scaled 3D reconstruction of the face is performed (which can also be done via RGB-cameras alone and an object of known size). All that remains is alignment in 3D of the known 3D face to the RGB image in question. Camera calibration (solved during 3D reconstruction of the face) can then be used to determine camera depth.
a. Can have device in any orientation—vertical or tilted, fixed-mounted, held by optician or sales associate, or held by user.
   i. The system can optionally leverage the device's gyroscope to determine in real-time the orientation of the device, and then compensate for any movement of the device during a measurement procedure (6-degrees of freedom compensation).
   ii. The system can also optionally leverage a depth sensor to understand how far (in metric scale) the camera is from the eyes and/or face at any given moment, and then properly compensate its measurements based on this information.
   iii. In the case where no depth sensor exists, knowledge of the camera distance to the face can be determined once camera calibration is provided or solved for, or an object of known size is visible to the RGB sensor (e.g. a credit card against the face). But for the most-accurate understanding of the distance of the camera to the eyes, the credit card should either be at the same camera distance as the eyes (hard to achieve), or in contact with the face. With the proper understanding of the 3D geometry of the face (solved ahead-of-time or during the procedure), the contact point of the credit card against the face (and simple homography of the card to understand its 3D orientation relative to the camera), the distance from the camera to the card contact point with the face can be solved for, and the distance from the card to the eyes can also be solved for, and thus the distance from the camera to the eyes can be known.
   iv. The system can also optionally leverage the device's gyro and knowledge of camera distance from the eyes/face to guide the user into an ideal placement of the device relative to the customer's face, and/or allow the user to hold the device at their preferred reading position with respect to their face, and leverage this fact to inform ophthalmic lens design software in order to create a lens design that is more personalized to the given user to maximize their visual acuity and satisfaction.
   v. Knowledge of camera distance can also inform the proper near pupillary distance to use for their Rx lenses.

Display dots on screen at known positions in metric scale (aka where on screen, and knowing screen pixel density), and optionally where said displayed dots are relative to camera in metric scale.

Have user look at each dot displayed.

System can optionally confirm that the eyes have indeed moved to converge on the new dot (comparing previous gaze position to new gaze position)

Optionally—said dot can animate/move on screen an in real-time the system can track the eye following the dot. Those with knowledge in the art can understand how a moving dot is more reliably tracked by the eye (with more reliable convergence) than a fixed dot.

System can look at movement of pupils and/or iris to determine the eye center-of-rotation and/or eye radius.

Furthermore, the system can real-time or in post-processing of captured frames, track not just the gaze direction, but also track the head position of the user by capturing and analyzing the 2D RGB images (face 2D tracking, and face yaw, pitch, roll estimation), and/or analyzing the 3D depth images (again to track the face and its orientation with respect to the depth camera). In real-time or in post-processing, the system can determine and compensate as the dots move on screen if the eyes change in gaze, and/or if the face position/orientation changes.
i. To determine face position/orientation changes with respect to the camera in 3D, one can leverage techniques known to those in the art, such as simultaneous location and mapping (SLAM), iterative closest point (ICP), etc—the 3D of the current depth image (known or determined from alignment of a prior 3D face to a new RGB image) can be compared to the last depth/RGB image captured, and/or can be compared to the first (starting) depth/RGB image captured, or any image capture in-between.

Solving for eye center-of-rotation and/or radius can inform ophthalmic lens design software in order to generate a truly personalized lens design that improves the visual acuity and/or satisfaction for a given user.

Solving for the ratio of eye vs head movement (horizontally and/or vertically) can also inform ophthalmic lens design software in order to generate a truly personalized lens design that improves the visual acuity and/or satisfaction for a given user and their unique “behavior” their “vision system”.

System can display dots in any color, and in any size, in order to improve the users compliance with tracking the dots. System can animate the dots in any manner needed to improve compliance (aka dots can start large and then shrink in size in order to attract attention, improve convergence and/or compliance, and then hone in on a specific point or location on the screen (in known metric distance from the camera)

System can move/animate the dots at any speed, even using real-time gaze feedback to adjust based on user's ability to (and compliance with) tracking.

Audio prompts can be optionally added to guide/assist the user in performing the requisite procedure.

Instead of dots, words/sentences/paragraphs of text can be displayed on screen, and the user can read said words as a given word is highlighted, changed in color, underlined, bolded, etc.

Or to allow users to read at their own pace, they could read aloud the words/sentences/paragraphs of text, and the system can analyze their voice to know where they are gazing at a given moment they say a word aloud. Alternatively or in conjunction, the system can use its camera(s) to read the lips of the user to know where they are gazing/reading at a given moment.

Prior knowledge of the customers Rx and lens design can allow the system to properly function while the user is wearing their current Rx glasses or OTC reading glasses. Allowing a presbyope to wear Rx glasses and/or readers will ensure they hold the device at their desired reading distance, and ensure the display will be in-focus (and not blurry). If they see a blurry screen, this can adversely affect their ability to accurately track dots/text on screen.
i. Knowledge of the Rx lens power, sphere, axis, and/or progressive lens design can allow the system to compensate for any distortion it will perceive when it looks at the pupils and/or the irises as the user gazes at dots/text displayed at different points on screen.
ii. Tracking of the face via 2D RGB or 3D depth maps can compensate or be tolerant of Rx eyewear (or OTC readers) being worn using techniques known to those familiar in the art).

For displays without known pixel-to-mm density, a standard calibration routine can be implemented to solve for pixel-to-mm of the display, a technique known to those familiar in the art. Furthermore, the metric scale distance from the camera to a desired point in the display can also be optionally determined using techniques known to those familiar in the art. Or a design (box, two dots, etc) can be displayed on the screen, and the user can measure in metric scale the distance between two displayed features and report the result, and/or they can adjust the size of a window, and as the displayed features grow/shrink in real-time as such adjustment is made, they can ensure the final result matches an object of known size (e.g. a credit card held up to the screen).

### Alignment and Reconstruction of Face Mesh

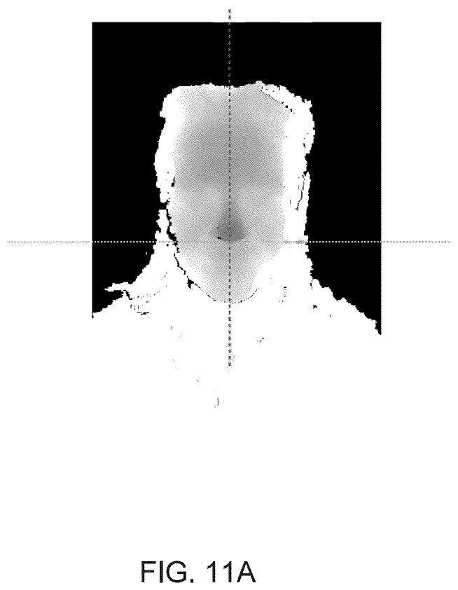

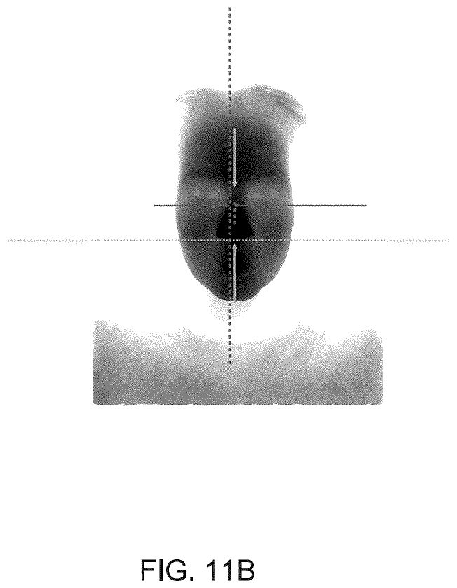

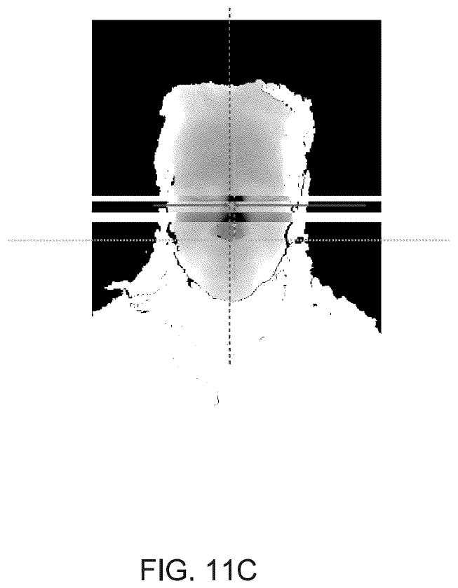

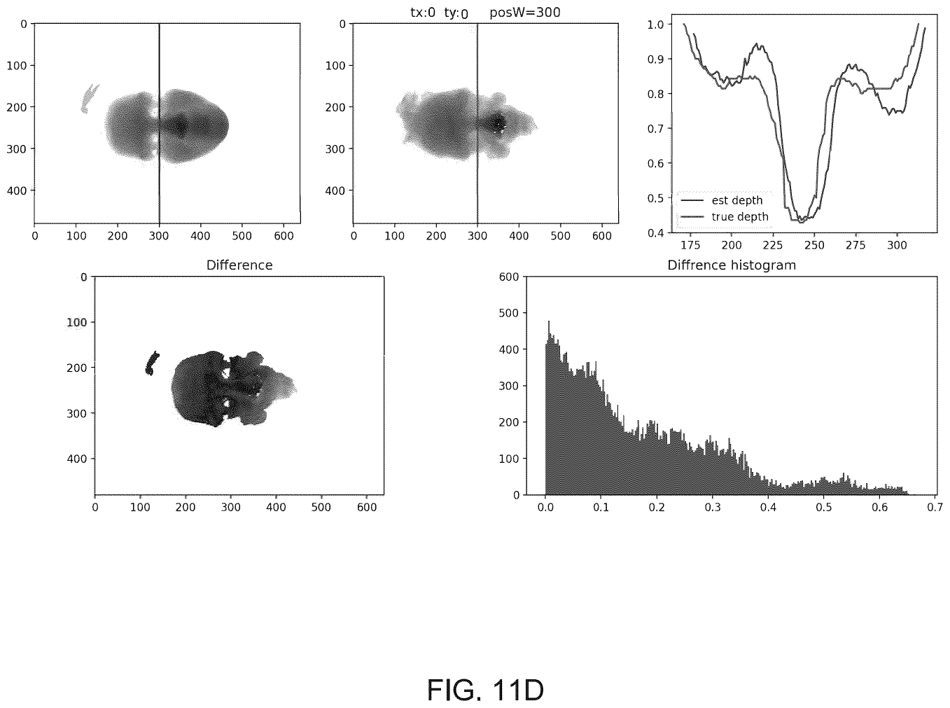

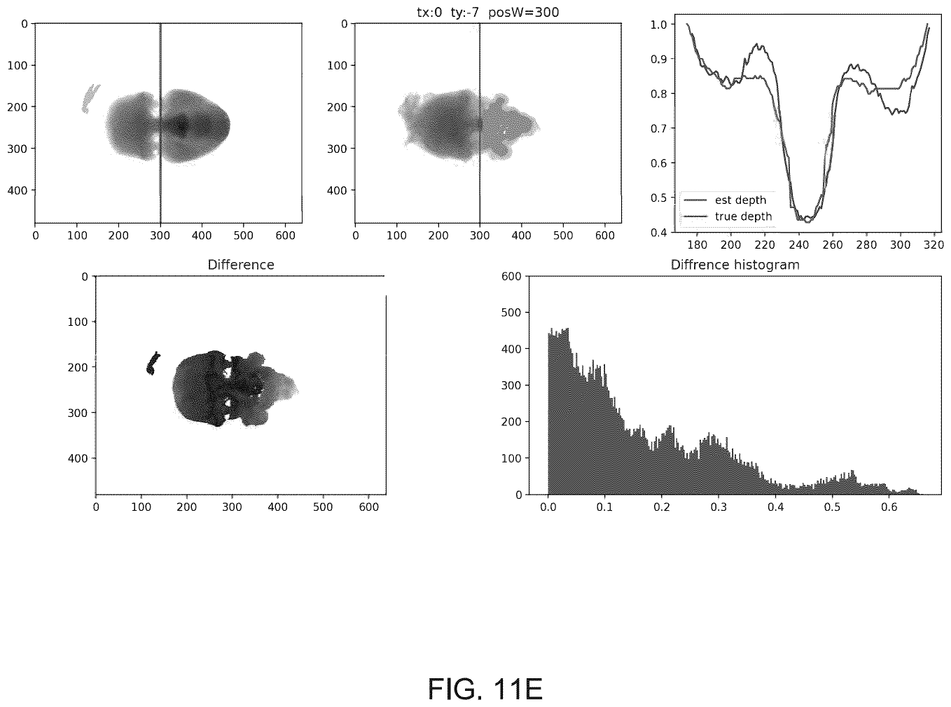

FIGS. 11A-11E illustrate the process of detecting and automatically correcting misalignment between RGB and depth sensors to ensure accurate facial modeling and eyewear recommendations. Misalignment between these sensors may lead to distorted depth maps, incorrect facial contours, misaligned texture-mapping, and ultimately, improper eyewear fitting. To address this, the system performs a muti-step calibration process, beginning with detecting discrepancies between RGB image feature and its corresponding depth data. This may involve identifying edge misalignment, depth inconsistencies in known reference points, or disparities in facial landmarks. Once misalignment is detected, the system may employ correction algorithms, such as machine-learning based alignment models, to synchronize the RGB and depth data. By continuously monitoring and adjusting for sensor misalignment, the system may ensure that facial reconstructions remain precise, thereby optionally can improving the accuracy of virtual eyewear try-on recommendations. This feature can also add value to the 3D reconstruction independent of an eyewear recommendation system.

FIG. 11A illustrates a depth-camera-equipped device where the depth and RGB images are misaligned, leading to discrepancies in facial feature mapping. The depth image, captured from the depth camera, highlights these misalignments. A dashed red line is positioned at the horizontal center of the nose (as determined by the depth camera's depth map output), serving as a reference for lateral alignment. Additionally, a dotted green line is placed vertically at the bottom tip of the nose, marking a key facial landmark. These visual guides may help in diagnosing and correcting depth-to-RGB misalignment.

FIG. 11B illustrates that the horizontal displacement of the center of the nose occurs when the AI-generated depth image, derived from the original RGB image, is aligned with the depth image captured by the depth sensors. Such initial alignment may be based on the current alignment provided by the camera system. In this case, there is no vertical displacement, as indicated by the alignment of the green dotted line, which remains consistent between the two images, however there can be instances in which vertical misalignment can also occur—this alignment technique may also be extended to detect and correct for vertical displacement, ensuring greater accuracy in mapping facial features. By refining both horizontal and vertical alignment, the system may provide more precisely aligned RGB and depth data for applications like virtual try-on and facial analysis.

FIG. 11C demonstrates a depth-camera-equipped device with misaligned depth and RGB images. To assist in perceiving the misalignment, a partial overlay of the two images is shown. This overlay may highlight the discrepancies between the depth image captured by the sensor and the corresponding RGB image, allowing for a clearer understanding of the horizontal and vertical shifts.

FIG. 11D illustrates debug plots that display a cross-section of two aligned depth images, indicated by the red and blue lines, revealing horizontal misalignment between the two depth layers. By examining the cross-sectional view, the horizontal offset becomes evident, with the red and blue lines showing slight shifts at specific points along the images.

FIG. 11E illustrates debug plots representing a 7-pixel translation of the real depth image to align it with the AI-generated depth image derived from the original RGB image. This translation may highlight the necessary offset to correct for misalignment between the two depth images. The system leverages alignment techniques, known to those familiar in the field, to automatically calculate and solve for the required offset for any given depth/RGB image pair. By applying these techniques, the system may ensure precise alignment. Alternatively, the depth data can remain untranslated, and the RGB data can be translated to align to the depth data. The translation to achieve proper alignment can be performed automatically by the system using methods known to those familiar in the art, and such automatic alignment can be performed once, or a regular basis, or in real-time.

When aligning two scans of a face for the purposes of determining the difference in camera positions and or face position/orientation from one scan to the next, or to apply features from one scan to that of another (aka as described in prior art, applying the eyes from one scan taken without glasses to another scan performed while wearing glasses), one can align the full 3D face scan mesh (created with no eyewear worn) to a single depth image (scan) with glasses worn (point cloud created from this second depth image). However, one need not align a face mesh to a point cloud to achieve this result. One can align two point clouds using the same ICP algorithm. Or either point cloud can be meshed prior to alignment. So one can align two point clouds, one meshed point cloud to a non-meshed point cloud, or two meshed point clouds.

Furthermore, a face mesh (with or without texture) that has been generated from RGB images can be aligned in 3D to subsequent RGB images captured from the same camera sensor, using alignment methods known to those familiar in the art such as image matching algorithms, feature and key point detectors, etc, and then subsequent bundle adjustment (via COLMAP, etc). In other words, the location in 3D of the face in subsequent RGB images can be known. This can also be done (with some level of reduced accuracy) across cameras using the textured 3D mesh by rendering the 3D mesh into a scene and figuring out the alignment between the two images (one rendered, one captured).

To reconstruct a 3D mesh from pure RGB images alone, one can following part or all of the following pipeline:
1) If the images are captured from a stationary camera and the user turns his/her face, first run a segmentation mask to remove the background and leave only the face. Such a mask can remove hair, or leave hair. Hair contains high-frequency details that can assist image matchers, but it can also be dynamic (especially if the hair is long) and can confuse such an algorithm
2) Run image matching on said segmented images. First detect keypoints and descriptors in the images using such methods as SIFT, SuperPoint, DISK, etc (other methods are known to those familiar in the art).
3) Then run feature matching or correspondence matching algorithms (such as LightGlue) across image pairs.
4) Then run bundle adjustment (using such methods incorporated into COLMAP) to find the 3D location of each matched point and build a 3D point cloud. You can speed up the computation if the input data is sequential, but this is optional if optimizing computational time is not a priority or input data is not sequential.
5) Optionally clean the resulting noisy point cloud using various outlier rejection methods, or optionally run a sophisticated AI model that handles noisy inputs and based on a prior training can better predict the final point cloud (and optionally mesh it)
6) Mesh the final point cloud
7) Texture the final mesh by projecting one or more images (where mesh is now perfectly aligned to the input images used to create it) and building a texture map (or blended texture map if more than one image is used). A method can be used to determine which images should be used to generate texture for different parts of the face. For example, the frontal portion of the face should be generated from a frontal image. But since a frontal image has limited visibility of the sides of the face, other images that better expose the sides (min and max facial yaw with respect to the camera) can be used for these portions of the face. Yaw angle can approximated via various methods known to those familiar in the art (such as Mediapipe's AI predictor or extraction of yaw from a 3D morphable model (3DMM), but accurate yaw is determined after bundle adjustment is completed.
8) To optionally scale the final mesh, an image containing an object of known size is required. Often this is a credit card. Capture one additional image containing a credit card in contact with a portion of the face (which can be estimated based on it's location in the image relative to the face), such as the tip of the nose, forehead, or mouth, and then a system can measure the edges or corners of the card (using various computer vision or segmentation techniques known to those in the art), leverage homography to understand the orientation of the card in 3D with respect to the camera (and face), and then measure the size of the card relative to the size of one or more detectable features of the face (such as detected irises or pupils), or relative to the entire 3D face mesh.
9) To detect other 3D landmarks on the face mesh (such as ear locations), one can use various methods. Three such methods are described below, but there are others that could be derived by those familiar in the art:
9a) Run custom AI landmark detectors on the original min/max yaw RGB images (or any image that has a clear view of the ears, but accuracy will be maximized at higher yaw, assuming the alignment of the mesh to the images at high yaw is also accurate), then find those 2D points in 3D space on the resulting face mesh
9b) Render the resulting textured 3D face mesh into a new (or existing) image at an orientation that best reveals the points to detect, then run a custom AI landmark detector to find said desired points on the mesh. In this case, there will be perfect correspondence (zero alignment error) between the 2D detection and location on the mesh/texture of said point.
9c) Run a custom AI landmark detector on the texture map of the 3D mesh. Doing so has a perfect correspondence between the 2D texture space and the 3D coordinate.
10) Optionally find a good correspondence between a live-mirror VTO powered by a 3DMM and the final reconstructed mesh. This can be done by rendering the reconstructed mesh into a blank canvas, or over input images (with pre-computed alignment), and then running the 3DMM on these images. The 2D to 3D correspondence of consistent landmarks on the 3DMM to the reconstructed 3D model can be found, and across images averaged, in order to pre-compute the proper alignment method(s). This can be done on a minimum of 3 landmark or mesh points on the 3DMM. In future use of the 3DMM on images, the reconstructed mesh can be aligned in 3D and then using the same projection matrix as the 3DMM, aligned to each image in the VTO.
11) the resulting face mesh can be subsequently aligned to new input RGB images using a subset of the above methods. This would allow for a VTO to be run on a new input stream, which could also enable a hybrid live-mirror VTO experience—aka initial images captured during a live-mirror VTO are used to reconstruct a face, and then the live mirror continues but behind the scenes a reconstructed 3D mesh is simply aligned to the subsequent input image of the live-mirror VTO. For performance reasons, a quick-to-compute 3DMM can power the VTO, and the refined 3D model can simply be aligned to it in real time, leveraging the proper alignment correspondence in step 10 above.

It should be appreciated that in the above description of example embodiments of the present disclosure, various features are sometimes grouped together in a single embodiment, figure, or description thereof for the purpose of streamlining the disclosure and aiding in the understanding of one or more of the various inventive aspects. This method of the present disclosure, however, is not to be interpreted as reflecting an intention that the claimed embodiments require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the present disclosure.

In the description provided herein, numerous specific details are set forth. However, it is understood that embodiments of the present disclosure are practiced without these specific details. In other instances, well-known methods, structures and techniques have not been shown in detail in order not to obscure an understanding of this description.

Thus, while there has been described what are believed to be the preferred embodiments of the present disclosure, those skilled in the art will recognize that other and further modifications are made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for recommending eyewear to a user, the computer-implemented method comprising:
receiving one or more images of a face of the user;
extracting spatial information from the one or more images using a deep learning model to estimate depth and contours of one or more facial features;
reconstructing a three-dimensional facial model based on the extracted spatial information, wherein the reconstruction includes aligning a face mesh with a reference object of known size or an alternative scaling mechanism;
tracking eye movement and analyzing gaze fixation points to determine natural viewing behavior; and
generating an eyewear recommendation based on the three-dimensional facial model and the analyzed viewing behaviors, wherein the recommended eyewear is selected to optimize fit and/or visual alignment.
